(19) United States
(12) Patent Application Publication
(10) Pub. No.: US 2026/0346806 A1
(43) Pub. Date: Nov. 5, 2026

(54) METHOD AND APPARATUS FOR GENERATING CONTROL LOGIC FOR SAFETY DEVICES OF A VEHICLE

(71) Applicants: HYUNDAI MOTOR COMPANY, Seoul (KR); Kia Corporation, Seoul (KR)

(72) Inventors: Dong Yeal LIM, Hwaseong-si (KR); Bo Pil SEO, Hwaseong-si (KR); Kwangcheol HAN, Hwaseong-si (KR)

(21) Appl. No.: 19/455,162

(22) Filed: Jan. 21, 2026

(30) Foreign Application Priority Data
May 2, 2025 (KR) 10-2025-0058013

(51) Int. Cl. B60R 21/015; G05B 17/02

(52) U.S. Cl. CPC B60R 21/01552; G05B 17/02

(57) ABSTRACT

A method and apparatus for deriving a control logic are provided. A method may include obtaining, via a driving simulation of a vehicle, vehicle behavior data associated with a vehicle collision; obtaining, by applying the obtained vehicle behavior data to an accident scenario reproduction model, a load level that is applied to the vehicle and a passenger of the vehicle; obtaining, based on the load level, a severity value of the vehicle collision; estimating, based on a safety analysis model, a passenger behavior and an injury; configuring, based on the passenger behavior and the injury, a full factorial design of experiments (DOE); estimating, based on the factorial DOE, one or more injury tendency values associated with the vehicle collision; and determining, based on the injury tendency values, a control logic and a time duration in which the control logic is to be activated.

### CROSS-REFERENCE TO RELATED APPLICATION

This application claims priority to and the benefit of Korean Patent Application No. 10-2025-0058013, filed in the Korean Intellectual Property Office on May 2, 2025, the entire contents of which are incorporated herein by reference.

### TECHNICAL FIELD

The disclosure relates to vehicle safety equipment, and more specifically to a method and apparatus for deriving control logic for a safety equipment of a vehicle.

### BACKGROUND

In some implementations, vehicle safety equipment control is manually performed based on crash characteristics of a vehicle body in an ordinary crash test mode with a seat position and angle fixed under a normal seating test condition. This control method may be designed for replicability under limited test conditions and a precise test environment. Thus, such a method may have limitations in testing diverse actual passenger seating positions and usage conditions. However, in an actual road environment, there may be differences in passenger usage environments such as various passenger physical conditions, seat positions, seat positions and angles, and seating habits. In other words, there may be complex driving environments and field accident scenarios that are difficult to predict and be tested. Accordingly, it may be difficult to sufficiently ensure passenger protection performance with some implementations of safety equipment control logic based only on typical test conditions.

The matters described in this Background section are only for enhancement of understanding of the background of the disclosure, and should not be taken as acknowledgement that they correspond to prior art already known to those skilled in the art.

### SUMMARY

The present disclosure attempts to provide a method and apparatus for deriving a control logic for a safety equipment of a vehicle, capable of providing an active and optimized safety equipment control logic that reflects a seating position of a passenger and a field usage condition.

According to one or more example embodiments of the present disclosure, a method performed by an apparatus of a vehicle may include: obtaining, via a driving simulation of the vehicle, vehicle behavior data associated with a vehicle collision of the vehicle; obtaining, by applying the obtained vehicle behavior data to an accident scenario reproduction model, a load level that is applied to the vehicle and a passenger of the vehicle; obtaining, based on the load level that is applied to the vehicle and the passenger, a severity value, of the vehicle collision, that indicates a severe accident scenario; estimating, based on a safety analysis model that considers a seating position of the passenger for the severe accident scenario, a passenger behavior and an injury; configuring, based on the passenger behavior and the injury, a full factorial design of experiments (DOE); estimating, based on the factorial DOE, one or more injury tendency values associated with the vehicle collision; determining, based on the injury tendency values, a control logic and a time duration in which the control logic is to be activated; and controlling, based on the control logic, an operation of the vehicle. Design factors of the full factorial DOE may include the seating position of the passenger.

Estimating the one or more injury tendency values may include: determining a human body part that is most affected by braking or colliding of the vehicle.

Estimating the one or more injury tendency values may include: plotting, on an x-axis, a position, of the human body part, at a time of the vehicle collision and plotting, on a y-axis, an injury value associated with the human body part.

The method may further include: determining the position of the human body part based on: a first indicator, associated with a driver's seat of the vehicle, corresponding to a shortest distance between a tip of a nose of the passenger and a steering wheel of the vehicle, and a second indicator, associated with a passenger's seat of the vehicle, corresponding to a shortest distance between a tip of a nose of a crash test dummy and a crash pad.

The method may further include: determining the injury value associated with the human body part based on a head injury criteria (HIC) value. The HIC value may be determined based on an integral of acceleration, of a head of a crash test dummy in the vehicle, over time.

Determining the time duration may include: classifying, based on the HIC value, the position of the human body part at the time of the vehicle collision.

Determining the time duration may further include: classifying the position of the human body part at the time of the vehicle collision further based on an instantaneous acceleration value of the body part exceeding a threshold value.

Determining the control logic may include: controlling vehicle safety equipment of the vehicle to adjust the position of the human body part at the time of the vehicle collision to belong to a different time section in a graph including the one or more injury tendency values.

Determining the control logic may include: controlling vehicle safety equipment of the vehicle to adjust the injury value of the human body part at the time of the vehicle collision to belong to a different time section in a graph including the one or more injury tendency values.

Estimating the one or more injury tendency values may include: performing, based on an analysis result of the factorial DOE, a first analysis using at least one of: a correlation chart, an analysis of means chart (ANOM), a response surface, or a snake view chart; and performing, based on a movement amount of a crash test dummy in the vehicle, a second analysis.

According to one or more example embodiments of the present disclosure, an apparatus may include a processor and a memory, The memory may store at least one instruction that is configured, when executed by the processor, to cause the apparatus to: perform a driving simulation of a vehicle; obtain, via the driving simulation, vehicle behavior data associated with a vehicle collision; obtain, by applying the obtained vehicle behavior data to an accident scenario reproduction model, a load level that is applied to the vehicle and a passenger of the vehicle; obtain, based on the load level that is applied to the vehicle and the passenger, a severity value, of the vehicle collision, that indicates a severe accident scenario; estimate, based on a safety analysis model that considers a seating position of the passenger for the severe accident scenario, a passenger behavior and an injury; configure, based on the passenger behavior and the injury, a full factorial design of experiments (DOE); estimate, based on the factorial DOE, one or more injury tendency values associated with the vehicle collision; determine, based on the injury tendency values, a control logic and a time duration in which the control logic is to be activated; and control, based on the control logic, an operation of the vehicle. Design factors of the full factorial DOE may include the seating position of the passenger.

The at least one instruction may be configured, when executed by the processor, to cause the apparatus to estimate the one or more injury tendency values by: determining a human body part that is most affected by braking or colliding of the vehicle.

The at least one instruction may be configured, when executed by the processor, to cause the apparatus to estimate the one or more injury tendency values by: plotting, on an x-axis, a position, of the human body part, at a time of the vehicle collision and plotting, on a y-axis, an injury value associated with the human body part.

The at least one instruction may be configured, when executed by the processor, to further cause the apparatus to: determine the position of the human body part based on: a first indicator, associated with a driver's seat of the vehicle, corresponding to a shortest distance between a tip of a nose of the passenger and a steering wheel of the vehicle, and a second indicator, associated with a passenger's seat of the vehicle, corresponding to a shortest distance between a tip of a nose of a crash test dummy and a crash pad.

The at least one instruction may be configured, when executed by the processor, to further cause the apparatus to: determine the injury value associated with the human body part based on a head injury criteria (HIC) value. The HIC value may be determined based on an integral of acceleration, of a head of a crash test dummy in the vehicle, over time.

The at least one instruction may be configured, when executed by the processor, to cause the apparatus to determine the time duration by: classifying, based on the HIC value, the position of the human body part at the time of the vehicle collision.

The at least one instruction may be configured, when executed by the processor, to cause the apparatus to determine the time duration further by: classifying the position of the human body part at the time of the vehicle collision further based on an instantaneous acceleration value of the body part exceeding a threshold value.

The at least one instruction may be configured, when executed by the processor, to cause the apparatus to determine the control logic by: controlling vehicle safety equipment of the vehicle to adjust the position of the human body part at the time of the vehicle collision to belong to a different time section in a graph including the one or more injury tendency values.

The at least one instruction may be configured, when executed by the processor, to cause the apparatus to determine the control logic by: controlling vehicle safety equipment of the vehicle to adjust the injury value of the human body part at the time of the vehicle collision to belong to a different time section in a graph including the one or more injury tendency values.

According to one or more example embodiments of the present disclosure, a non-transitory computer-readable medium may store instructions that, when executed by a computing device, cause the computing device to: obtain, via a driving simulation of a vehicle collision of a vehicle, vehicle behavior data associated with the vehicle collision; identifying, based on the vehicle behavior data, a relationship between one or more positions of a body part of a passenger of the vehicle and corresponding injury severity values; determining, based on the relationship between the one or more positions of the body part and the corresponding injury severity values, a control logic for safety equipment of the vehicle; and controlling, based on the control logic, the safety equipment of the vehicle.

### BRIEF DESCRIPTION OF THE DRAWINGS

FIG. 1 illustrates a flowchart for describing an example control logic deriving apparatus for a safety equipment of a vehicle.

FIG. 2 illustrates a flowchart for describing an example control logic deriving method for a safety equipment of a vehicle.

FIGS. 3, 4, 5 and 6 illustrate views for describing implementation examples related to a method and apparatus for deriving a control logic for a safety equipment of a vehicle.

FIG. 7 illustrates a block diagram showing an example computing device.

### DETAILED DESCRIPTION

Hereinafter, the present disclosure will be described more fully with reference to the accompanying drawings, in which one or more example embodiments of the disclosure are shown. As those skilled in the art would realize, the described example embodiment(s) may be modified in various different ways, all without departing from the spirit or scope of the present disclosure. Accordingly, the drawings and description are to be regarded as illustrative in nature and not restrictive. Like reference numerals designate like elements throughout the specification.

In addition, throughout the specification and claims, unless explicitly described to the contrary, the word “comprise” and variations such as “comprises” or “comprising” will be understood to imply the inclusion of stated elements but not the exclusion of any other elements. Terms including ordinal numbers such as first, second, and the like will be used only to describe various components, and are not to be interpreted as limiting these components. The terms are only used to differentiate one component from other components.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Unless otherwise defined, the terms used herein, including technical or scientific terms, may have meanings generally understood by those skilled in the art to which the present disclosure belongs.

The expressions such as “comprise,” “may comprise,” “include,” “may include,” “have,” “may have,” etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip,” “second chip,” respectively.

The term “unit” as used herein may refer to software, or hardware component such as Field-Programmable Gate Array (FPGA), Application Specific Integrated Circuit (ASIC), etc. However, “unit” is not limited to hardware and software. The “unit” may be configured to be stored in an addressable storage medium, or may be configured to execute one or more processors. The “unit” may include components such as software components, object-oriented software components, class components, and task components, as well as processors, functions, attributes, procedures, subroutines, segments of program code, drivers, firmware, microcode, circuits, data, databases, data structures, tables, arrays, and variables.

The expression “based” on as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic purpose processor capable of performing the specific operation by executing software, or to a special purpose computer structured through programming to perform the specific operation.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., applying vehicle behavior data into an accident scenario reproduction model) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., applying vehicle behavior data into an accident scenario reproduction model) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., applying vehicle behavior data into an accident scenario reproduction model) described herein.

Minimum risk maneuver (MRM) operation(s) may also be controlled, for example, based on one or more features (e.g., applying vehicle behavior data into an accident scenario reproduction model) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., applying vehicle behavior data into an accident scenario reproduction model) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

An autonomous driving level and/or autonomous driving activation/deactivation may also be controlled, for example, based on one or more features (e.g., applying vehicle behavior data into an accident scenario reproduction model) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as 5 seconds, 30 seconds, 1 minute, etc.). By changing the required user attentiveness, the driver may be required to look ahead more often (e.g., at least once in a threshold time period, such as 5 seconds, 30 seconds, 1 minute, etc.). By changing the autonomous driving level, one or more video contents may not be displayed on a display of the vehicle.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., applying vehicle behavior data into an accident scenario reproduction model) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), engaging and/or disengaging an autonomous driving mode, etc.). One or more auxiliary devices (e.g., engine brake, exhaust brake, hydraulic retarder, electric retarder, regenerative brake, etc.) may also be controlled, for example, based on one or more features (e.g., applying vehicle behavior data into an accident scenario reproduction model) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., evaluating the engagement state of the driver) described herein.

The vehicle that an autonomous driving system is actively controlling may be referred to as an ego vehicle, a host vehicle, or an autonomous vehicle. The ego vehicle may also be referred to as a self-driving car, an autonomous car (AC), a driverless car, a robotaxi, a robotic car, or a robo-car. The ego vehicle may be the vehicle that is equipped with the autonomous driving system. Alternatively, the autonomous driving system may control the ego vehicle, for example, from an external and/or remote device, such as a server. The ego vehicle can be partially or wholly controlled (e.g., piloted, driven, etc.) remotely by a remote human driver. A car that is ahead of the ego vehicle (e.g., in the same driving lane as the ego vehicle) may be referred to as a vehicle in front (e.g., a vehicle directly in front), a vehicle ahead (e.g., a vehicle directly ahead), a lead vehicle, a leading vehicle, or a preceding vehicle. A car that follows the ego vehicle (e.g., in the same driving lane as the ego vehicle) may be referred to as a car behind, a trailing vehicle, a following vehicle, or a succeeding vehicle. An adjacent vehicle may refer to any vehicle located in any direction (e.g., front, rear, left, right, diagonal, etc.) from the ego vehicle as long as no other vehicles (e.g., intervening vehicles) exist between it and the ego vehicle (e.g., regardless of the distance from the ego vehicle). Alternatively, in some contexts, only those vehicles that are located within a threshold distance (e.g., line of sight and/or detection limit of one or more sensors of the ego vehicle) from the ego vehicle may be referred to as adjacent vehicles. A target vehicle may be any vehicle that is near the ego vehicle (e.g., within a threshold distance away from the ego vehicle). The target vehicle may be any vehicle that the autonomous driving system monitors, recognizes, identifies, tracks, and/or analyzes, either actively or passively, either once or multiple times, and either sporadically or continuously. The threshold distance may be, for example, the line of sight and/or the detection limit of one or more sensors of the ego vehicle, but the threshold distance may be a value (e.g., an adjustable value) that is less than the line of sight and/or the detection limit of the one or more sensors of the ego vehicle. The target vehicle can be, for example, a vehicle in front, a vehicle behind, a vehicle in a different lane than the driving lane of the ego vehicle (e.g., a vehicle to the left, a vehicle to the right, a vehicle in a diagonal direction, etc.), and/or an adjacent vehicle (e.g., regardless of the distance from the ego vehicle and/or regardless of whether there are intervening vehicle(s) between the target vehicle and the ego vehicle). A target vehicle may also be referred to as a surrounding vehicle, a nearby vehicle, an external vehicle, another vehicle (other vehicles), and so forth.

Terms such as “part,” “portion,” “module,” etc., described in the specification may indicate a unit capable of processing at least one function or operation described in the specification, and this may be implemented by hardware (e.g., circuit, control circuit, processor, etc.), software, or a combination of hardware or a circuit and software. Furthermore, at least some of the components or functions of the method and apparatus for deriving a control logic for a safety equipment of a vehicle according to the example embodiment(s) described below may be implemented as a program or software, and the program or software may be stored in a computer-readable recording medium or storage medium.

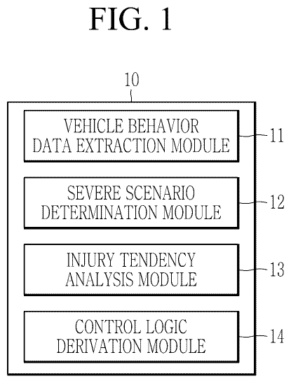

FIG. 1 illustrates a flowchart for describing an example control logic deriving apparatus for a safety equipment of a vehicle.

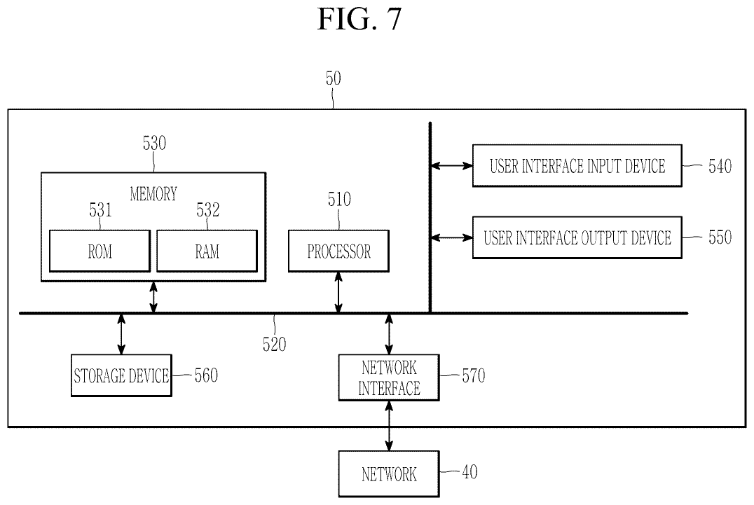

Referring to FIG. 1, the control logic deriving apparatus 10 for the safety equipment of the vehicle may be implemented as a computing device including a processor and a memory. For example, the control logic deriving apparatus 10 may be implemented as a computing device 50 as described below with reference to FIG. 7. In this case, the processor may correspond to a processor 510 of the computing device 50, and the memory may correspond to a memory 520 of the computing device 50. Alternatively, the control logic deriving apparatus 10 may include one or more non-transitory computer-readable media including instructions and one or more processors for executing the instructions to perform operations. Herein, the operations may include a configuration, a function, a step, etc. described in this specification with respect to the control logic deriving method and apparatus according to example embodiment(s). In this specification, the term “module” is used to logically distinguish these operations performed by the control logic deriving method and apparatus according to the present disclosure.

The control logic deriving apparatus 10 may include a vehicle behavior data extraction module 11, a severe scenario determination module 12, an injury tendency analysis module 13, and a control logic derivation module 14.

The vehicle behavior data extraction module 11 may extract (e.g., obtain) vehicle behavior data related to crash occurrence (e.g., vehicle collision) by performing a vehicle driving simulation. The vehicle behavior data extraction module 11 may perform a driving simulation in a specific accident scenario such as an intersection crash, a rear-end crash, an overlap crash occurring during a lane change, etc., or in an unspecified random traffic environment, based on a pre-prepared simulation tool or a co-simulation environment with the pre-prepared traffic tool.

The vehicle behavior data extract module 11 may continuously collect dynamic behavior information such as real-time positions, velocity, acceleration, steering angles, and brake operations of the test vehicle and a surrounding vehicle during the simulation, and may extract (e.g., obtain) vehicle behavior data corresponding to a time from, e.g., 5 seconds before the crash to 1 second after the crash based on a time of a crash occurrence (e.g., vehicle collision). In some example embodiment(s), vehicle behavior data may be stored in a standardized file format (e.g., comma separated values (.csv)).

The severe scenario determination module 12 may input vehicle behavior data extracted by the vehicle behavior data extraction module 11 into an accident scenario reproduction model, may determine (e.g., calculate) a load level applied to the vehicle and the passenger, and may determine severity of the accident to determine a severe accident scenario. Specifically, the severe scenario determination module 12 may configure an accident reproduction model by including physical property information of the test vehicle and the opposing vehicle, and pre-crash vehicle behavior data and accident scenario information provided from the vehicle behavior data extraction module 11 as accident scenario input values. Additionally, the severe scenario determination module 12 may determine (e.g., calculate) the load level applied to the vehicle and the passenger by evaluating the configured accident scenario reproduction model, and may additionally obtain vehicle behavior data at a time after the crash (In-Crash). Based on such a load determination (e.g., calculation) result and a vehicle dynamics analysis result, the severity (e.g., severity value) of each accident scenario may be quantitatively evaluated, and the severe scenario determination module 12 may determine the accident scenario as a severe accident scenario if the severity (e.g., severity value) exceeds a certain reference. The severe accident scenarios derived at this time may correspond to a scenario with a high impact strength and a high possibility of causing a serious injury to a passenger.

The injury tendency analysis module 13 may evaluate passenger behavior and injury using a safety analysis model that considers a seating position of the passenger for a severe accident scenario. In this case, the seating position may be considered as a variable by considering a seat position, a seat back angle, a seating depth, etc., reflecting passenger's actual usage conditions. In addition, the injury tendency analysis module 13 may configure a full factorial design of experiments (DOE) according to design factors including the seating position based on data on passenger behavior and injuries. In addition, the injury tendency analysis module 13 may analyze an injury tendency (e.g., one or more injury tendency values that indicate likelihood of the passenger sustaining injury) based on a full factorial DoE.

Herein, the full factorial DoE may indicate an experimental design technique that performs analysis by configuring all possible combinations of levels of each factor for all design factors included in the experiment. The full factorial DoE may have an advantage of being able to quantitatively evaluate not only a main effect of each factor but also an interaction effect between factors, and may be useful for precisely analyzing effects of design factors on passenger behavior and injury levels.

For example, if a crash mode has six levels (e.g., frontal, right-angle, small overlap, offset, left-angle, and low-velocity crash) and the seating position has 18 levels, the full factorial DoE may quantitatively evaluate passenger behavior and injury response for all combinations of variables by performing analyses for each of the 108 conditions. Through this process, a probability of injury occurrence for each combination may be identified, and a trend showing a sharp increase in injury under a specific condition may be detected, and this may allow for determining a risk condition that requires a control logic.

The injury tendency analysis module 13 may perform a first correlation analysis using a correlation chart, an analysis of means chart (ANOM), a response surface, or a snake view chart technique based on the analysis result performed by the factorial DoE, and may perform a second analysis based on a dummy (e.g., crash test dummy) movement amount. Accordingly, a first correlation analysis may visually derive a relationship between design factors and variables that have a major impact on injury, and a second analysis may additionally analyze injury sensitivity based on position-based data such as a dummy's head movement distance and a change in seating position.

The injury tendency analysis module 13 may derive (e.g., determine) a body portion (e.g., body part). most affected (e.g., vulnerable to injury) by vehicle braking or crash. For example, if an impact analysis based on an interpretation result shows that a head portion experiences higher acceleration than other body portions during braking or crash, head injury may be identified as a portion to which priority should be given.

The injury tendency analysis module 13 may analyze an injury tendency (e.g., one or more injury tendency values that indicate likelihood of the passenger sustaining injury) by defining a position of a human body portion at a time of the crash as an x-axis (e.g., plotting the position of the human body part at the time of the vehicle crash on the x-axis) and an injury value of the human body portion as a y-axis (e.g., plotting the injury value associated with the human body part on the y-axis). Herein, a position value of the human body portion may be determined using a first indicator defined as a shortest distance between a tip of the passenger's nose and a steering wheel for a driver's seat, and a second indicator defined as a shortest distance between a tip of the dummy's nose (e.g., the nose of the crash test dummy that is seated in the passenger's seat) and a crash pad for a passenger's seat. Using these first and second indices, the seating position of passengers may be expressed quantitatively. An injury value of the human body portion may be determined using a head injury criteria (HIC) value, which may be determined (e.g., calculated) by integrating (e.g., determining an integral of) the dummy's head's acceleration over time. HIC may be an indicator that numerically expresses a degree of injury. For example, the greater the value of the HIC is, the greater the degree of injury may be.

The control logic derivation module 14 may derive (e.g., determine) a control logic application section and a control logic non-application section from the injury tendency analyzed by the injury tendency analysis module 13.

The control logic derivation module 14 may classify a position of the human body portion (e.g., human body part such as a head) at the time of the crash according to the HIC value to derive (e.g., determine) the control logic application section and non-application section. In this case, for example, a reference HIC value may be applied as HIC 560, which is 80% of HIC 700 corresponding to an abbreviated injury scale (AIS) grade 3 level, and if the reference value is exceeded, it may be derived as a risk section requiring application of a control logic. Accordingly, the control logic derivation module 14 may identify a head position of the relevant section, and may derive (e.g., determine, generate, etc.) a control logic capable of minimizing the risk of injury.

The control logic derivation module 14 may classify the position of the human body portion at the time of the crash according to the HIC value, and may derive the control logic application section and the control logic non-application section by additionally considering a bottom out indicator defined as when a head (e.g., body part) acceleration instantaneous value (e.g., an instantaneous acceleration value of the body part) exceeds a threshold value (e.g., 80 G). A bottom-out phenomenon may refer to a situation in which a head of the dummy (e.g., crash test dummy) directly contacts the internal structure of the vehicle during a vehicle collision, causing rapid injury, and the control logic derivation module 14 may derive a section in which this phenomenon is likely to occur as a risk section requiring control logic application.

The control logic derivation module 14 may derive a control logic that is activated in the derived control logic application section. The derived control logic may be set based on specifications of the safety equipment mounted in the vehicle, as well as a response time, an operating pressure, and a deployment method, and a control method such as early operation, delayed operation, and load adjustment may be designed in response to each application section.

The control logic derivation module 14 may change a position of a human body portion at a time of the crash to belong to a different section (e.g., different time duration or section) in a graph analyzing injury tendency through safety equipment control prior to the time of the crash. In other words, vehicle safety equipment of the vehicle may be controlled to adjust (e.g., move) the position of the human body part at the time of crash to belong to a different time section in a graph analyzing the one or more injury tendency values. For example, by directing a passenger's head position to a non-hazardous section through control, it may be possible to move a passenger out of a hazard section at the time of the crash. Such pre-control may be a control logic that reduces a risk of injury particularly at a time prior to a crash (e.g., vehicle collision).

The control logic derivation module 14 may change an injury value of the human body portion at the time of the crash to belong to a different section in the graph analyzing the injury tendency through safety equipment control after the time of the crash. In this case, the injury value may be moved from an existing risk section to a non-risk section by reducing a load applied to the head portion through control. This may be a response control in a post-crash situation, and may be a control logic for protecting passengers immediately after a crash.

It may be possible to derive and apply an optimized safety equipment control logic according to a crash situation by reflecting the passenger's seating position and a field usage condition, so it may be possible to implement an active safety control system capable of flexibly responding to an actual accident situation rather than a passive control method based on existing fixed test conditions. In addition, by analyzing the passenger position and the injury tendency at the time of the crash and applying a control strategy suitable for the pre-crash and in-crash situations, it may contribute to reducing a major injury indicator such as a head injury below a reference value, and improve safety performance of the vehicle.

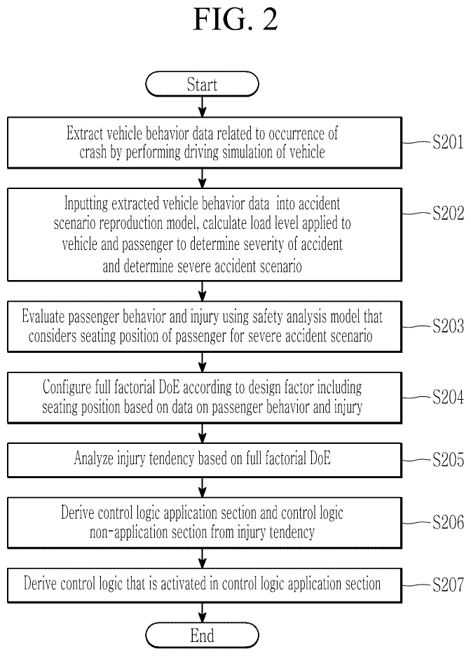

FIG. 2 illustrates a flowchart for describing an example control logic deriving method for a safety equipment of a vehicle.

For convenience, FIG. 2 is described by way of an example in which the steps are performed by a processor, such as one or more of the modules as shown in FIG. 1. One, some, or all steps of the example method of FIG. 2, or portions thereof, may be performed by one or more other circuits (e.g., processors, circuits, control circuits, etc.). One or more steps of the example method of FIG. 2 may be omitted, performed in other orders, and/or otherwise modified, and/or one or more additional steps may be added.

Referring to FIG. 2, according to a method for generating a virtual scenario, a processor may extract vehicle behavior data related to (e.g., associated with) an occurrence of a crash by performing a driving simulation of a vehicle (S201). The processor may input the extracted vehicle behavior data into an accident scenario reproduction model, and determine (e.g., calculate) a load level applied to the vehicle and a passenger to determine severity (e.g., severity value) of an accident and determining a severe accident scenario (S202). The processor may, for example, determine the load level by applying the obtained vehicle behavior data to the accident scenario reproduction model. The processor may determine, based on the load level, a severity value, of an accident, that indicates a severe accident scenario. The processor may evaluate passenger behavior and injury using a safety analysis model that considers a seating position of the passenger for the severe accident scenario (S203). The processor may configure a full factorial DoE according to a design factor including the seating position based on data on passenger behavior and an injury (S204). The processor may analyze injury tendency (e.g., an injury value or level) based on the full factorial DoE (S205). The processor may derive (e.g., generate) a control logic application section and a control logic non-application section from the injury tendency (S206). The processor may derive (e.g., generate) a control logic that is activated in the control logic application section (S207).

For more detailed information related to the above method, a reference may be made to the description of one or more other example embodiments included in this specification, so a redundant description will be omitted.

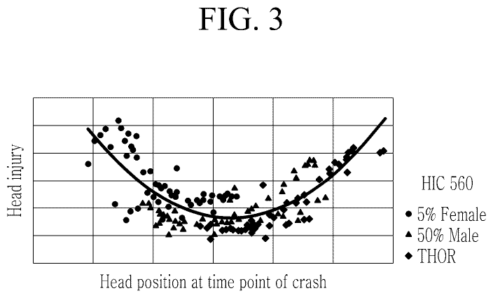

FIGS. 3, 4, 5, and 6 illustrate views for describing implementation examples related to a method and apparatus for deriving a control logic for a safety equipment of a vehicle.

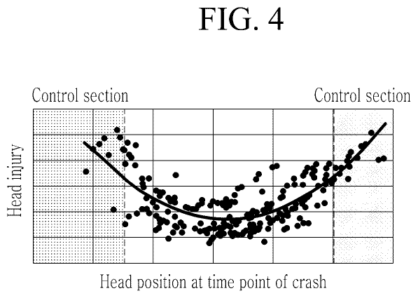

Referring to FIGS. 3 and 4, it is shown that a control logic application section is derived based on a head injury value. A reference HIC value may be applied as HIC 560, which is 80% of HIC 700 corresponding to an abbreviated injury scale (AIS) grade 3 level, and if the reference value is exceeded, it may be derived as a risk section requiring application of a control logic.

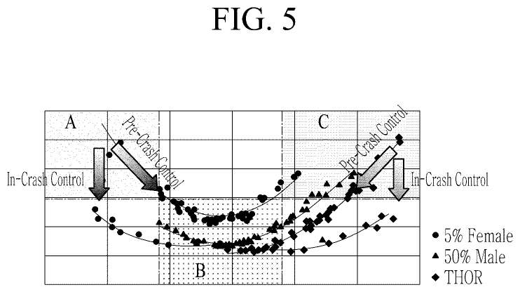

Referring to FIG. 5, the derived safety control logic may be divided into control at an operation before a time of the crash (e.g., Pre-Crash) and control at an operation after the time of the crash (e.g., In-Crash), and each control operation may have the following directionality. First, in the pre-crash operation, a position of the passenger's head before the crash occurs may be controlled to induce a position to be in a section B, which has a relatively low risk based on an injury tendency analysis graph, thereby reducing a risk of injury in advance. In the in-crash operation, safety equipment control may be performed to reduce a head injury value of a passenger positioned in a section A or a section C to below a reference injury value in response to a crash situation that has already occurred.

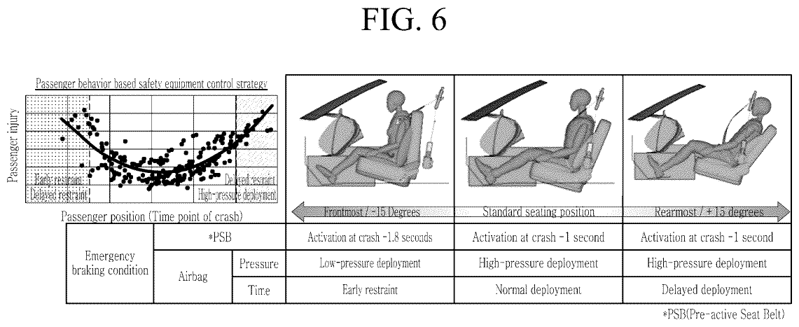

Referring to FIG. 6, a safety equipment integrated safety control logic may be formed of three operations: inference, assessment, and control.

In the inference operation, a passenger's actual seating position may be determined (e.g., calculated) by utilizing seat-related information such as a seat position, a height, and a seatback angle. In the assessment operation, a passenger behavior estimation logic may be used to predict passenger's dynamic behavior based on a vehicle behavior factor such as a control CAN signal, a braking deceleration force, and steering information of the vehicle. In the control operation, a safety equipment control logic derived according to the present disclosure may be driven. This logic may determine the optimal safety equipment control strategy for an accident situation by comprehensively considering a passenger's initial position and predicted behavior. If it is determined that passenger's behavior and injury would be excessive with only an existing standard safety equipment in a crash situation, the control logic may minimize passenger injury by appropriately responding to a corresponding situation and adjusting an operating time, a method, a load, etc. of the safety equipment.

The safety equipment may be controlled as follows, depending on the passenger's seating position at the time of the crash (e.g., collision). When a passenger's seating position is positioned further forward than a standard seating position, the safety equipment may be set to be activated early and operate at a load equal to or less than the standard safety equipment. If the passenger's seating position is positioned further rearward than the standard seating position, the safety equipment may be delayed in operation and adjusted to be activated with a greater load than that of the standard safety equipment. In addition, a safety equipment with new technologies such as a dual depth airbag and a pre-safe seat may be activated in a separate control method other than the control method specified herein.

FIG. 7 illustrates a block diagram showing an example computing device.

Referring to FIG. 7, a method and apparatus for deriving a control logic for a safety equipment of a vehicle may be implemented using a computing device 50. The computing device 50 may be implemented as various forms of electronic devices, servers, or similar devices, and their functions may be implemented through a combination of software and hardware.

The computing device 50 may include at least one of a processor 510, a memory 530, a user interface input device 540, a user interface output device 550, and a storage device 560 which communicate each other via a bus 520. The computing device 50 may also include a network interface 570 electrically connected to a network 40. The network interface 570 may transmit or receive signals to or from other elements through the network 40.

The processor 510 may be implemented as various types of computational devices, such as a micro controller unit (MCU), an application processor (AP), a central processing unit (CPU), a graphic processing unit (GPU), a neural processing unit (NPU), a quantum processing unit (QPU), etc. The processor 510 may be a semiconductor device that executes instructions stored in a memory 530 or a storage device 560, and may play a key role in the system. Program codes and data stored in the memory 530 or the storage device 560 may instruct the processor 510 to perform specific tasks, thereby enabling a general operation of the system. The processor 510 may be configured to implement various functions and methods described above with respect to FIGS. 1 to 6.

The memory 530 and the storage device 560 may include various forms of volatile or non-volatile storage media for storing and accessing data of the system. For example, the memory 530 may include a read only memory (ROM) 531 and a random access memory (RAM) 532. The memory 530 may be embedded within the processor 510, in which case a data transmission speed between the memory 530 and the processor 510 may be very fast. The memory 530 may be positioned external to the processor 510, in which case the memory 530 may be connected to the processor 510 via various data buses or interfaces. This connection may be made through a variety of means, e.g., a peripheral component interconnect express (PCIe) interface for high-speed data transfer or through a memory controller.

At least some of the components or functions of the method and apparatus for deriving a control logic for a safety equipment of a vehicle may be implemented as a program or software running on the computing device 50, and the program or software may be stored on a computer-readable recording medium or storage medium. Specifically, a computer-readable recording medium or storage medium may be a program recorded on a computer including the processor 510 that executes a program or command stored in the memory 530 or the storage device 560 to execute operations included in the implementation of the method and apparatus for deriving a control logic for a safety equipment of a vehicle based on model profiling.

At least some of the components or functions of the method and apparatus for deriving a control logic for a safety equipment of a vehicle may be implemented using hardware or circuitry of the computing device 50, or may be implemented as separate hardware or circuitry that can be electrically connected to the computing device 50.

The computing device 50 may be provided with one or more non-transitory computer-readable media containing executable instructions, which, when executed by one or more processors of the computing device 50, cause the computing device 50 to perform operations. Herein, the operations may include a configuration, a function, a step, etc. described in this specification with respect to the method and apparatus for deriving a control logic for a safety equipment of a vehicle.

It may be possible to derive and apply an optimized safety equipment control logic according to a crash situation by reflecting the passenger's seating position and a field usage condition, so it may be possible to implement an active safety control system capable of flexibly responding to an actual accident situation rather than a passive control method based on existing fixed test conditions. In addition, by analyzing the passenger position and the injury tendency at the time of the crash (e.g., collision) and applying a control strategy suitable for the pre-crash and in-crash situations, it may contribute to reducing a major injury indicator such as a head injury below a reference value, and improve safety performance of the vehicle.

A method for deriving control logic for a safety equipment of a vehicle, performed by a computing device including a processor and a memory, the method including extracting, by the processor, vehicle behavior data related to crash occurrence by performing a driving simulation of the vehicle, inputting, by the processor, the extracted vehicle behavior data into an accident scenario reproduction model, calculating a load level applied to the vehicle and a passenger to determine severity of an accident and determine a severe accident scenario, evaluating, by the processor, passenger behavior and an injury using a safety analysis model that considers a seating position of the passenger for the severe accident scenario, configuring, by the processor, a full factorial design of experiments (DOE) according to a design factor including the seating position based on data on the passenger behavior and the injury, analyzing, by the processor, injury tendency based on the factorial DOE, deriving, by the processor, a control logic application section and a control logic non-application section from the injury tendency, and deriving, by the processor, a control logic that is activated in the control logic application section.

The analyzing of the injury tendency may include deriving, by the processor, a human body portion that is most affected by braking or a crash of the vehicle.

The analyzing of the injury tendency may include analyzing, by the processor, the injury tendency by defining the position of the human body portion at a time point of crash as an x-axis and an injury value of the human body portion as a y-axis.

A position value of the human body portion may be determined using a first indicator defined as a shortest distance between a tip of a passenger's nose and a steering wheel for a driver seat, and a second indicator defined as a shortest distance between a tip of a dummy's nose and a crash pad for a passenger seat.

An injury value of the human body portion may be determined using a head injury criteria (HIC) value, which is calculated by integrating the dummy's head acceleration over time.

The deriving of the control logic application section and the control logic non-application section may include classifying, by the processor, the position of the human body portion at the time of collision according to the HIC value to derive the control logic application section and the control logic non-application section.

The deriving of the control logic application section and the control logic non-application section may include deriving, by the processor, the control logic application section and the control logic non-application section by classifying a position of the human body portion at a time point of crash according to the HIC value and additionally considering a bottom out indicator defined as when the head acceleration instantaneous value exceeds 80 G.

The deriving of the control logic that is activated in the control logic application section may include changing, by the processor, a position of the human body portion at a time point of crash to belong to a different section in a graph analyzing the injury tendency through safety equipment control prior to the time point of crash.

The deriving of the control logic that is activated in the control logic application section may include changing, by the processor, an injury value of the human body portion at a time point of crash to belong to a different section in a graph analyzing the injury tendency through safety equipment control after the time point of crash.

The analyzing of the injury tendency may further include performing, by the processor, a first correlation analysis using a correlation chart analysis of means chart (ANOM), a response surface, or a snake view chart technique based on an analysis result performed by the factorial DoE, and performing a second analysis based on a dummy movement amount.

A control logic deriving apparatus may include one or more non-transitory computer-readable media containing instructions, and one or more processors configured to execute the instructions to perform an operation, wherein the operation may include extracting vehicle behavior data related to craft occurrence by performing a driving simulation of a vehicle, inputting the extracted vehicle behavior data into an accident scenario reproduction model, calculating a load level applied to the vehicle and a passenger to determine severity of an accident and determine a severe accident scenario, evaluating passenger behavior and an injury using a safety analysis model that considers a seating position of the passenger for the severe accident scenario, configuring a full factorial design of experiments (DOE) according to a design factor including the seating position based on data on the passenger behavior and the injury, analyzing injury tendency based on the factorial DOE, deriving a control logic application section and a control logic non-application section from the injury tendency, and deriving a control logic that is activated in the control logic application section.

The analyzing of the injury tendency may include deriving a human body portion that is most affected by braking or a crash of the vehicle.

The analyzing of the injury tendency may include analyzing the injury tendency by defining the position of the human body portion at a time point of crash as an x-axis and an injury value of the human body portion as a y-axis.

A position value of the human body portion may be determined using a first indicator defined as a shortest distance between a tip of a passenger's nose and a steering wheel for a driver seat, and a second indicator defined as a shortest distance between a tip of a dummy's nose and a crash pad for a passenger seat.

An injury value of the human body portion may be determined using a head injury criteria (HIC) value, which is calculated by integrating the dummy's head acceleration over time.

The deriving of the control logic application section and the control logic non-application section may include classifying the position of the human body portion at the time of collision according to the HIC value to derive the control logic application section and the control logic non-application section.

The deriving of the control logic application section and the control logic non-application section may include deriving the control logic application section and the control logic non-application section by classifying a position of the human body portion at a time point of crash according to the HIC value and additionally considering a bottom out indicator defined as when the head acceleration instantaneous value exceeds 80 G.

The deriving of the control logic that is activated in the control logic application section may include changing a position of the human body portion at a time point of crash to belong to a different section in a graph analyzing the injury tendency through safety equipment control prior to the time point of crash.

The deriving of the control logic that is activated in the control logic application section may include changing an injury value of the human body portion at a time point of crash to belong to a different section in a graph analyzing the injury tendency through safety equipment control after the time point of crash.

A computer-readable medium may include one or more non-transitory computer-readable media containing instructions executable by a computing device, wherein the instructions, when executed by one or more processors of the computing device, cause the computing device to perform an operation, the operation including extracting vehicle behavior data related to craft occurrence by performing a driving simulation of a vehicle, inputting the extracted vehicle behavior data into an accident scenario reproduction model, calculating a load level applied to the vehicle and a passenger to determine severity of an accident and determine a severe accident scenario, evaluating passenger behavior and an injury using a safety analysis model that considers a seating position of the passenger for the severe accident scenario, configuring a full factorial design of experiments (DOE) according to a design factor including the seating position based on data on the passenger behavior and the injury, analyzing injury tendency based on the factorial DOE, deriving a control logic application section and a control logic non-application section from the injury tendency, and deriving a control logic that is activated in the control logic application section.

While the present disclosure has been described in connection with example embodiments, it is to be understood that the present disclosure is not limited to the disclosed example embodiments, but, on the contrary, is intended to cover various modifications and equivalent arrangements included within the spirit and scope of the appended claims.

What is claimed is:

1. A method performed by an apparatus of a vehicle, the method comprising:
obtaining, via a driving simulation of the vehicle, vehicle behavior data associated with a vehicle collision of the vehicle;
obtaining, by applying the obtained vehicle behavior data to an accident scenario reproduction model, a load level that is applied to the vehicle and a passenger of the vehicle;
obtaining, based on the load level that is applied to the vehicle and the passenger, a severity value, of the vehicle collision, that indicates a severe accident scenario;
estimating, based on a safety analysis model that considers a seating position of the passenger for the severe accident scenario, a passenger behavior and an injury;
configuring, based on the passenger behavior and the injury, a full factorial design of experiments (DOE), wherein design factors of the full factorial DOE comprises the seating position of the passenger;
estimating, based on the factorial DOE, one or more injury tendency values associated with the vehicle collision;
determining, based on the injury tendency values, a control logic and a time duration in which the control logic is to be activated; and
controlling, based on the control logic, an operation of the vehicle.

2. The method of claim 1, wherein the estimating of the one or more injury tendency values comprises:
determining a human body part that is most affected by braking or colliding of the vehicle.

3. The method of claim 2, wherein the estimating of the one or more injury tendency values comprises:
plotting, on an x-axis, a position, of the human body part, at a time of the vehicle collision and plotting, on a y-axis, an injury value associated with the human body part.

4. The method of claim 3, further comprising:
determining the position of the human body part based on:
a first indicator, associated with a driver's seat of the vehicle, corresponding to a shortest distance between a tip of a nose of the passenger and a steering wheel of the vehicle, and
a second indicator, associated with a passenger's seat of the vehicle, corresponding to a shortest distance between a tip of a nose of a crash test dummy and a crash pad.

5. The method of claim 3, further comprising:
determining the injury value associated with the human body part based on a head injury criteria (HIC) value, wherein the HIC value is determined based on an integral of acceleration, of a head of a crash test dummy in the vehicle, over time.

6. The method of claim 5, wherein the determining of the time duration comprises:
classifying, based on the HIC value, the position of the human body part at the time of the vehicle collision.

7. The method of claim 6, wherein the determining of the time duration further comprises:
classifying the position of the human body part at the time of the vehicle collision further based on an instantaneous acceleration value of the body part exceeding a threshold value.

8. The method of claim 5, wherein the determining of the control logic comprises:
controlling vehicle safety equipment of the vehicle to adjust the position of the human body part at the time of the vehicle collision to belong to a different time section in a graph comprising the one or more injury tendency values.

9. The method of claim 5, wherein the determining of the control logic comprises:
controlling vehicle safety equipment of the vehicle to adjust the injury value of the human body part at the time of the vehicle collision to belong to a different time section in a graph comprising the one or more injury tendency values.

10. The method of claim 1, wherein the estimating of the one or more injury tendency values comprises:
performing, based on an analysis result of the factorial DOE, a first analysis using at least one of: a correlation chart, an analysis of means chart (ANOM), a response surface, or a snake view chart; and
performing, based on a movement amount of a crash test dummy in the vehicle, a second analysis.

11. An apparatus comprising:
a processor; and
a memory storing at least one instruction that is configured, when executed by the processor, to cause the apparatus to:
perform a driving simulation of a vehicle;
obtain, via the driving simulation, vehicle behavior data associated with a vehicle collision;
obtain, by applying the obtained vehicle behavior data to an accident scenario reproduction model, a load level that is applied to the vehicle and a passenger of the vehicle;
obtain, based on the load level that is applied to the vehicle and the passenger, a severity value, of the vehicle collision, that indicates a severe accident scenario;
estimate, based on a safety analysis model that considers a seating position of the passenger for the severe accident scenario, a passenger behavior and an injury;
configure, based on the passenger behavior and the injury, a full factorial design of experiments (DOE), wherein design factors of the full factorial DOE comprises the seating position of the passenger;
estimate, based on the factorial DOE, one or more injury tendency values associated with the vehicle collision;
determine, based on the injury tendency values, a control logic and a time duration in which the control logic is to be activated; and
control, based on the control logic, an operation of the vehicle.

12. The apparatus of claim 11, wherein the at least one instruction is configured, when executed by the processor, to cause the apparatus to estimate the one or more injury tendency values by:
determining a human body part that is most affected by braking or colliding of the vehicle.

13. The apparatus of claim 12, wherein the at least one instruction is configured, when executed by the processor, to cause the apparatus to estimate the one or more injury tendency values by:
plotting, on an x-axis, a position, of the human body part, at a time of the vehicle collision and plotting, on a y-axis, an injury value associated with the human body part.

14. The apparatus of claim 13, wherein the at least one instruction is configured, when executed by the processor, to further cause the apparatus to:
determine the position of the human body part based on:
a first indicator, associated with a driver's seat of the vehicle, corresponding to a shortest distance between a tip of a nose of the passenger and a steering wheel of the vehicle, and
a second indicator, associated with a passenger's seat of the vehicle, corresponding to a shortest distance between a tip of a nose of a crash test dummy and a crash pad.

15. The apparatus of claim 13, wherein the at least one instruction is configured, when executed by the processor, to further cause the apparatus to:
determine the injury value associated with the human body part based on a head injury criteria (HIC) value, wherein the HIC value is determined based on an integral of acceleration, of a head of a crash test dummy in the vehicle, over time.

16. The apparatus of claim 15, wherein the at least one instruction is configured, when executed by the processor, to cause the apparatus to determine the time duration by:
classifying, based on the HIC value, the position of the human body part at the time of the vehicle collision.

17. The apparatus of claim 16, wherein the at least one instruction is configured, when executed by the processor, to cause the apparatus to determine the time duration further by:
classifying the position of the human body part at the time of the vehicle collision further based on an instantaneous acceleration value of the body part exceeding a threshold value.

18. The apparatus of claim 15, wherein the at least one instruction is configured, when executed by the processor, to cause the apparatus to determine the control logic by:
controlling vehicle safety equipment of the vehicle to adjust the position of the human body part at the time of the vehicle collision to belong to a different time section in a graph comprising the one or more injury tendency values.

19. The apparatus of claim 15, wherein the at least one instruction is configured, when executed by the processor, to cause the apparatus to determine the control logic by:
controlling vehicle safety equipment of the vehicle to adjust the injury value of the human body part at the time of the vehicle collision to belong to a different time section in a graph comprising the one or more injury tendency values.

20. A non-transitory computer-readable medium storing instructions that, when executed by a computing device, cause the computing device to:
obtain, via a driving simulation of a vehicle collision of a vehicle, vehicle behavior data associated with the vehicle collision;
identifying, based on the vehicle behavior data, a relationship between one or more positions of a body part of a passenger of the vehicle and corresponding injury severity values;
determining, based on the relationship between the one or more positions of the body part and the corresponding injury severity values, a control logic for safety equipment of the vehicle; and
controlling, based on the control logic, the safety equipment of the vehicle.
